(19) United States
(12) Patent Application Publication
(10) Pub. No.: US 2011/0104429 A1
(43) Pub. Date: May 5, 2011

(54) SUBSTRATE MEMBER, MODULE, ELECTRIC EQUIPMENT, AND MANUFACTURING METHOD OF MODULES

(75) Inventors: Masahiko Kushino, Osaka-shi (JP); Masahiro Murakami, Osaka-shi (JP); Shinichi Tokuno, Osaka-shi (JP)

(73) Assignee: Sharp Kabushiki Kaisha, Osaka (JP)

(21) Appl. No.: 12/832,353

(22) Filed: Jul. 8, 2010

(30) Foreign Application Priority Data
Oct. 30, 2009 (JP) 2009-249689

(51) Int. Cl. B32B 3/02; B32B 3/30; B29C 65/00

(52) U.S. Cl. 428/76; 264/272.14; 428/156; 428/172

(57) ABSTRACT

A substrate member is a manufacturing component of a module including electronic components mounted on a substrate and sealed with resin. The substrate member has substantially a plate-like shape and is to be the substrate later. A manufacturing process of the modules includes a mounting step of mounting electronic components on a component side of the substrate member, and a sealing step of supplying resin to flow on the component side so that the mounted electronic components are sealed with the resin. The mounting step includes mounting a first electronic component having substantially a flat mounting surface in a first mounting region specified on the component side so that a gap is formed between the mounting surface and the component side. The component side is provided with a first groove for boosting the resin to fill up the gap in the sealing step. Thus, insufficient filling of the resin in the gap between the substrate member and the electronic component is suppressed.

### CROSS-REFERENCE TO RELATED APPLICATIONS

This application is based on Japanese Patent Application No. 2009-249689 filed on Oct. 30, 2009, the contents of which are hereby incorporated by reference.

### BACKGROUND OF THE INVENTION

1. Field of the Invention

The present invention relates to a substrate member, a module manufactured by using the same, and a manufacturing method of modules.

2. Description of Related Art

Conventionally, there is a module that is used as a component of electric equipment, which is manufactured by using a substrate member and the like. In addition, for a convenience of specifications of the like of the module, there is a module in which an electronic component that is mounted on a module substrate so as to form a gap (e.g., an electronic component used for flip chip mounting) is used, and the mounted electronic components are sealed with resin. Here, an example of the manufacturing process of modules will be described briefly.

The manufacturing process of module generally includes a mounting step of mounting electronic components on a predetermined substrate member (that includes a plurality of module substrate connected to each other), a sealing step of supplying resin to flow on the component side of the substrate member so as to seal the mounted electronic components, and a cutting step of cutting the substrate member together with resin along boundaries between module substrates to be separated into pieces.

The substrate member has a structure as illustrated in FIG. 11. Specifically, the substrate member 130 is like a plate including a conductor layer and an insulator layer, in which individual parts (to be separated into pieces after the cutting step) are connected to each other at boundaries 131 illustrated in broken lines. In addition, on the component side of each part, there are determined regions for mounting various electronic components like a mounting region 132 in which an electronic component (e.g., an IC chip of a narrow gap specification) so as to form a gap.

Then, in the mounting step, as illustrated in FIG. 12, various types of electronic components 140 are mounted in the determined region on the component side of the substrate member 130, like an electronic component 140a that is mounted so as to form a gap. The electronic component 140a is mounted by flip chip mounting, for example, in the mounting region 132 of each part so as to form a gap.

In addition, in the sealing step, the substrate member 130 after the mounting step is put in a mold, and resin is supplied to flow on the component side of the substrate member 130. When the resin is cured, the individual electronic components 140 are sealed. In this way, by the transfer mold method, for example, the individual electronic components 140 are sealed. By the above-mentioned process, the mounted substrate 130 with a resin layer formed on the component side is obtained.

Then, in the cutting step, the substrate member 130 is cut together with the resin layer along the boundaries 131 to be separated into pieces. A necessary process is performed on the separated piece to be finally the module as a finished product. FIG. 13 illustrates a structural diagram of the module that is manufactured by the above-mentioned series of steps. Note that the upper part of FIG. 13 illustrates a top view of the module 100 (the sealing member 112 is transparent for convenience sake), and the lower part illustrates a cross sectional view taken along the line XX′.

As illustrated in FIG. 13, the module 100 has a structure in which the individual electronic components 140 are mounted on the component side of the module substrate 111 (that is a separated piece of the substrate member 130) and are sealed with a sealing member 112 (that is a separated piece of the resin layer). In this way, since the individual electronic components 140 are sealed with resin, the individual electronic components 140 are protected from impacts or the like, so that quality of the module 100 can be maintained.

Here, about the above-mentioned sealing step, filling of the resin in the gap between the substrate member 130 and the electronic component 140a will be described with reference to FIG. 14. Note that FIG. 14 illustrates schematically resin flow in the vicinity of the mounting region 132 on the component side. Since the gap is opened at the edge of the mounting region 132 toward the outside of the gap, the resin flows into the gap from the opening portion as illustrated by white arrows in FIG. 14.

However, if the gap (distance between the substrate member 130 and the electronic component 140a) is relatively narrow (e.g., narrow gap of 100 μm or smaller), sufficient quantity (to fill up the gap completely) of resin may not flow in from the opening portion. Particularly as illustrated in FIG. 14, as being away from the opening portion, i.e., as being closer to the center of the mounting region 132, the resin is hardly supplied so that insufficient filling of the resin (remaining air) is apt to occur.

If such insufficient filling of the resin occurs, it is difficult to maintain quality of the module. For instance, when the module is mounted on electric equipment by soldering, air remaining in the gap may be expanded so that an excessive pressure may be applied to the module.

### SUMMARY OF THE INVENTION

In view of the above-mentioned problem, an object of the present invention is to provide a substrate member that can suppress insufficient filling of the resin in the gap between the substrate member and the electronic component as much as possible. In addition, it is another object of the present invention to provide a manufacturing method of modules using the substrate member, electric equipment using the module, and a module manufactured by the manufacturing method.

In order to achieve the above-mentioned object, a substrate member of the present invention is a manufacturing component of a module including electronic components mounted on a substrate and sealed with resin. The substrate member has substantially a plate-like shape and is to be the substrate later. A manufacturing process of the modules includes a mounting step of mounting electronic components on a component side of the substrate member, and a sealing step of supplying resin to flow on the component side so that the mounted electronic components are sealed with the resin. The mounting step includes mounting a first electronic component having substantially a flat mounting surface in a first mounting region specified on the component side so that a gap is formed between the mounting surface and the component side, and the component side is provided with a first groove for boosting the resin to fill up the gap in the sealing step.

With this structure, since the first groove is formed on the component side of the substrate member, filling of the resin in the gap between the substrate member and the electronic component is boosted compared with the case without the first groove. Therefore, insufficient filling of the resin in the gap can be suppressed as much as possible.

In addition, in the above-mentioned structure, the first groove may be formed so as to pass through the first mounting region.

With this structure, the resin can flow so as to pass through the first mounting region when the resin is supplied to flow in the first groove. Since at least a part of the resin flow in the first groove enter the gap, filling of the resin in the gap is boosted.

In addition, as the above-mentioned structure, more specifically, an outer edge of the substrate member has substantially a rectangular shape, and the first groove is formed so as to extend from one side of the outer edge of the substrate member to the other side opposed to the one side.

In addition, in the above-mentioned structure, the sealing step uses a transfer mold method in which the resin is supplied to flow in substantially the same direction along the component side of the substrate member, and the first groove is formed so that the extending direction thereof is substantially the same as the direction of the resin flow.

With this structure, a power of the resin flow by the transfer mold method can be utilized so that the resin can flow also in the first groove. Therefore, the resin flow in the first groove becomes smooth, and entering of the resin into the gap can be boosted more.

In addition, as the above-mentioned structure, more specifically, a width of the first groove in the first mounting region is adapted to increase along the direction of the resin flow.

In addition, in the above-mentioned structure, in the mounting step, the first electronic component is mounted on the substrate member by gluing bumps of the mounting surface to predetermined positions in the first mounting region, and the first groove is formed so as to avoid the part where the bumps are glued.

With this structure, it is possible that the appropriate mounting of the first electronic component is not disturbed by the first groove. In addition, it is possible that the resin can flow easily in the first groove in the sealing step.

In addition, in the above-mentioned structure, the first groove is formed so as to pass through substantially the middle of the first mounting region. With this structure, it is possible to supply the resin to enter the gap from substantially the middle in the first mounting region, so that filling of the resin in the gap can be performed efficiently.

In addition, in the above-mentioned structure, the substrate member includes individual parts that are to be substrates of different modules, and the parts are connected in the extending direction of the component side. The manufacturing process of the modules includes cutting the substrate member together with the resin after the sealing step along the boundaries between the parts so as to separate the same, and a second groove for the resin to flow in the sealing step is formed along the boundaries on the component side.

With this structure, the portion of the substrate member to be cut becomes relatively thin, so that the cutting can be performed easily.

In addition, as the above-mentioned structure, more specifically, the second groove is a V-shaped groove having an angle of substantially 90 degrees or smaller.

In addition, in the above-mentioned structure, the substrate member includes an insulator layer to be an insulation coating of the modules and a conductor layer to be wiring patterns for the modules, and a depth of the second groove is deeper than the insulator layer and the conductor layer.

With this structure, the resin can be supplied to flow to the insulator layer and the conductor layer. Therefore, when the substrate member is cut along the second grooves and is separated into pieces, the insulator layer and the conductor layer of the cut end are covered with the resin so that it is possible to prevent these layers from being exposed.

In addition, a manufacturing method of modules according to the present invention uses the substrate member having the above-mentioned structure as a manufacturing component. According to this method, the module can be manufactured while utilizing the above-mentioned merits of the substrate member.

In addition, another manufacturing method of modules according to the present invention is a manufacturing method of a module including a substrate on which electronic components are mounted and sealed with resin. The method includes a mounting step of mounting the electronic components on a component side of a substrate member that has substantially a plate-like shape and is to be the substrate later, and a sealing step of supplying resin to flow on the component side so that the mounted electronic components are sealed with the resin. The mounting step includes mounting a first electronic component having substantially a flat mounting surface in a first mounting region specified on the component side so that a gap is formed between the mounting surface and the component side, the component side is provided with a first groove that passes through the first mounting region, and the sealing step includes supplying the resin to flow also in the first groove so that the resin flows from the first groove to the gap in the first mounting region for boosting the resin to fill up the gap.

According to this method, filling of the resin in the gap between the substrate member and the first electronic component is boosted. Therefore, insufficient filling of the resin in the gap can be suppressed as much as possible.

In addition, in the above-mentioned manufacturing method, the mounting step includes mounting passive components having substantially a rectangular parallelepiped shape on the component side of the substrate member, the sealing step uses a transfer mold method in which the resin is supplied to flow in substantially the same direction along the component side of the substrate member, and all the passive components mounted on the component side in the mounting step are mounted so that the longitudinal directions of the passive components are substantially the same as the direction of the resin flow.

According to this method, it is possible that the resin flow in the sealing step is not disturbed by the passive components as much as possible.

In addition, as the above-mentioned manufacturing method, more specifically, in the mounting step, the first electronic component is mounted on the component side of the substrate member so that the gap is 100 μm or smaller.

In addition, a module according to the present invention is manufactured by the above-mentioned manufacturing method. According to this module, it is possible to enjoy the above-mentioned merits of the manufacturing method in the manufacturing steps. In addition, this module is used as one of components of electric equipment (e.g., communication equipment).

### BRIEF DESCRIPTION OF THE DRAWINGS

The above-mentioned and other objects and features of the present invention will be apparent from the following description about a preferred embodiment with reference to the attached drawings as follows.

FIG. 1 is a structural diagram of a high frequency module according to an embodiment of the present invention.

FIG. 2 is an external view of the high frequency module.

FIG. 3 is a structural diagram of a substrate member according to the embodiment of the present invention.

FIG. 4 is an explanatory diagram about an IC chip according to the embodiment of the present invention.

FIG. 5 is an explanatory diagram illustrating the substrate member on which electronic components are mounted.

FIG. 6 is an explanatory diagram about a mounting manner of the IC chip.

FIG. 7 is an explanatory diagram about a sealing step in the embodiment of the present invention.

FIG. 8 is an explanatory diagram about resin flow near a first mounting region.

FIG. 9 is a structural diagram of a substrate member in another form according to the embodiment of the present invention.

FIG. 10 is a structural diagram of a substrate member in still another form according to the embodiment of the present invention.

FIG. 11 is a structural diagram about an example of a conventional substrate member.

FIG. 12 is an explanatory diagram of the substrate member on which electronic components are mounted.

FIG. 13 is a structural diagram about an example of a conventional module.

FIG. 14 is an explanatory diagram about resin flow in a conventional sealing step.

### DETAILED DESCRIPTION OF THE PREFERRED EMBODIMENTS

An embodiment of the present invention will be described below with reference to a high frequency module that is used as a component of communication equipment.

[Structure Etc. of Module]

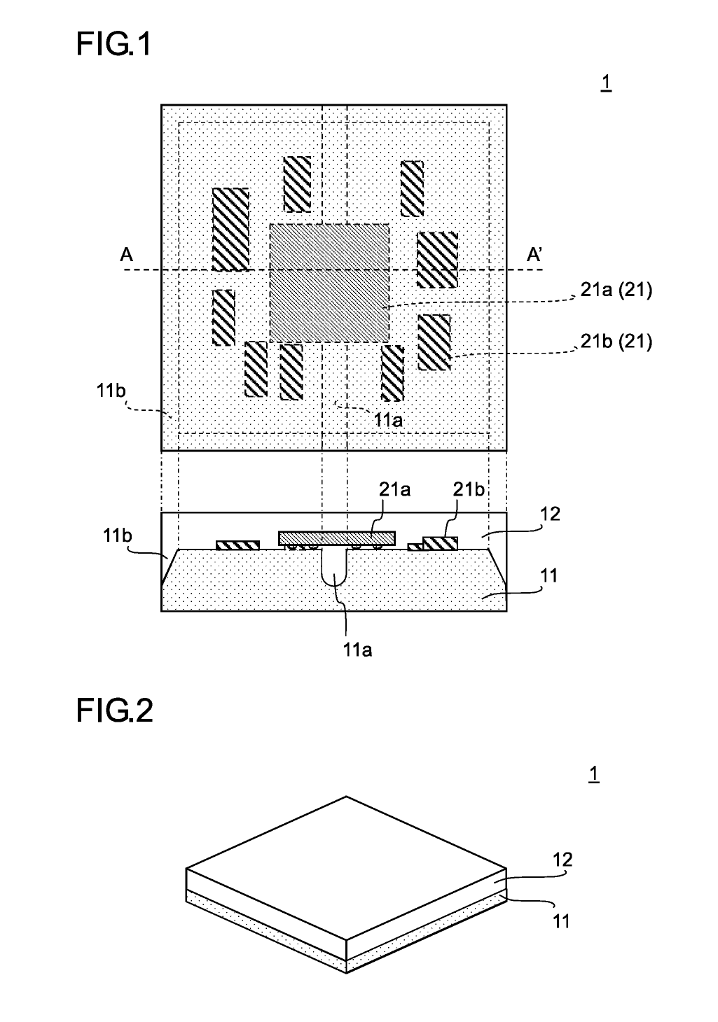

FIG. 1 is a structural diagram of a high frequency module (one form of the module) according to an embodiment of the present invention. FIG. 2 is an external view (perspective view) of the high frequency module 1. In FIG. 1, a top view of the high frequency module 1 (a sealing member 12 is transparent for convenience sake) is illustrated in the upper part, while a cross sectional view taken along the line AA′ is illustrated in the lower part.

As illustrated in FIG. 1, the high frequency module 1 has a general structure in which various electronic components 21 are mounted on a component side of a module substrate 11, and these electronic components 21 are sealed with the sealing member 12.

The module substrate 11 is formed in a square shape in a plan view, which has four sides (outer edges, each of which is approximately 6 mm). In addition, the module substrate 11 includes an insulator layer forming an insulator coating material or the like and a conductor layer forming a wiring patterns or the like disposed in this order from the upper side (component side). On the component side, a part of the insulator layer is removed, for example, so that a conductor layer is exposed at the part for mounting an electronic component.

On the other hand, a plurality of external connection terminals (not shown) are formed on the underside surface (opposite surface to the component side) of the module substrate 11. The external connection terminals are connected electrically to the above-mentioned wiring patterns by via holes or through holes, for example. The external connection terminals are connected electrically to terminals of a main body side of the communication equipment when the high frequency module 1 is built in the main body of the communication equipment (one type of the electric equipment). Thus, the high frequency module 1 can communicate signals with individual portions of the communication equipment so as to work as one component of the communication equipment.

The electronic components 21 mounted on the component side of the module substrate 11 are connected electrically with each other by the wiring patterns and the via holes. Note that the electronic components 21 include an IC chip 21a having substantially a plate-like shape and passive components (resistors, inductors, capacitors, and the like) 21b having substantially a rectangular parallelepiped shape.

The individual electronic components 21 are disposed so as to work as a tuner, for example, as a whole. Thus, the high frequency module 1 can be used as a tuner (tuner module) in communication equipment.

In addition, the sealing member 12 is made of an insulating resin such as epoxy resin and is formed on the component side of the module substrate 11 so as to seal all the electronic components 21. The sealing member 12 has the same square shape as the module substrate 11 in a plan view. In addition, four side surfaces of the sealing member 12 are respectively flush with the four side surfaces of the module substrate 11. In addition, the sealing member 12 performs a role of protecting the electronic components 21 by sealing the electronic components 21.

Note that a groove portion 11a and a slope portion 11b are formed on the component side of the module substrate 11, as illustrated in FIG. 1 (particularly in the cross sectional view. The groove portion 11a is formed so as to cross the component side from one side to the opposite side of the outer edges at substantially the middle of the component side. In addition, the groove portion 11a passes through substantially the middle of the region in which the IC chip 21a is mounted.

In addition, the slope portions 11b is inclined in the in-and-out direction of the module substrate 11 and is formed along substantially the entire length (four sides) of the outer edges on the component side. The slope portion 11b is covered with the sealing member 12 so as not to be exposed to the outside.

The above-mentioned high frequency module 1 is generally manufactured by performing the steps in the order, which include a mounting step of mounting predetermined mounting electronic components 21 on the substrate member (one of manufacturing components of the high frequency module 1, which is a plurality of module substrate 11 that are connected with each other), a sealing step of supplying resin to flow on the component side of the substrate member so as to seal the mounted electronic components 21, and cut the substrate member together with resin at boundaries between module substrates 11 so as to separate the same into pieces. Hereinafter, a structure and the like of this substrate member, and a manufacturing process and the like of the high frequency module 1 will be described in more detail.

[Structure Etc. of Substrate Member]

First, a structure and the like of the substrate member will be described.

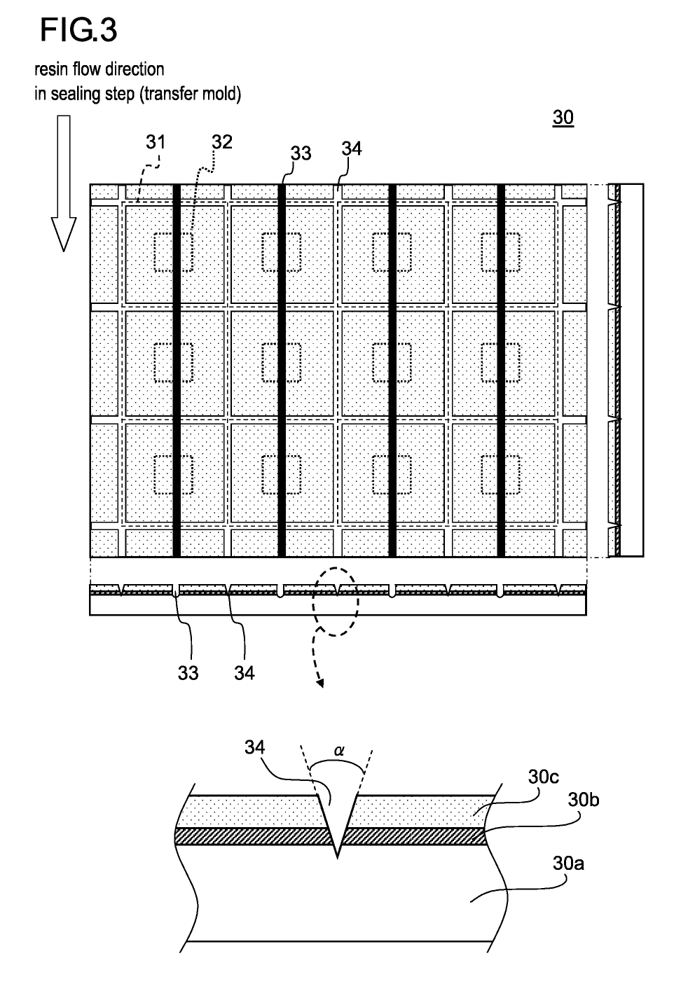

FIG. 3 is a structural diagram of the substrate member 30. In FIG. 3, diagrams of the substrate member 30 viewed from three directions (upper side, lower side, and right side) is illustrated in the upper part, and an enlarged view of the part encircled by the broken line is illustrated in the lower part. Note that a first groove 33 is filled with black so as to be distinguished easily from a second groove 34.

As illustrated in FIG. 3, the substrate member 30 has a rectangular outer edges and a plate-like shape. In the thickness direction, a base layer 30a, a conductor layer 30b, and an insulator layer 30c are laminated in this order from the opposite side (underside) to the component side. The conductor layer 30b and the insulator layer 30c become the conductor layer and the insulator layer of the module substrate 11 later. In addition, a resin flow direction (see FIG. 7) on the substrate member 30 in the sealing step (using a transfer mold method) is determined in advance as illustrated by the arrow in FIG. 3.

The substrate member 30 is formed integrally in the plan view, but it is cut later in the cutting step at boundaries 31 (between module substrates 11) illustrated by the broken lines in FIG. 3. In addition, each separated part of the substrate member 30 becomes the module substrate 11. Therefore, the substrate member 30 can be considered to be the individual parts (parts enclosed by the boundaries 31) to be separate module substrates 11 later, which are connected at the boundaries 31 in the extending direction of the component side.

According to the substrate member 30 illustrated in FIG. 3, three in the vertical direction and four in the horizontal direction, i.e., total twelve of parts are connected. However, this is merely an example, and other form may be adopted (usually, larger number of parts are connected in an actually adopted form). In addition, the substrate member 30 may not be the plurality of connected parts but be a single module substrate 11 later.

Further, in the substrate member 30, a first mounting region 32 that is a region where the IC chip 21 is mounted later is provided to each part. In the first mounting region 32, the wiring patterns and the like are formed so as to enable flip chip mounting of the IC chip 21 (bumps formed on the IC chip 21 in advance are bonded to the component side for mounting).

In addition, in the substrate member 30, the first groove 33 is formed so as to extend from one side to the opposite side of the outer edges of the substrate member 30 and to pass through the first mounting region 32 of each part. In addition, the first groove 33 is formed so as to pass through the middle of the first mounting region 32 of each part. Note that the direction in which the first groove 33 extends is set to be substantially the same as the direction of the resin flow in the sealing step.

The first groove 33 is formed mainly for boosting the resin to fill a gap 54 that will be described later in the sealing step. In addition, a shape and a size of a cross section of the first groove 33 are set so that melted resin can flow therein smoothly to a certain extent (at least, more smoothly than a flow in the gap 54). This point will be described later again.

Further, in the substrate member 30, second grooves 34 are formed in the position corresponding to the above-mentioned boundaries 31. The second groove 34 is formed as a V-shaped groove having a V-shaped cross section as illustrated in FIG. 3 (particularly in the lower part). An angle α of the V shape is 90 degrees or smaller (e.g., 60 degrees). A depth of the second groove 34 reaches the base layer 30a (i.e., a position deeper than the insulator layer 30c and the conductor layer 30b).

The second grooves 34 are formed mainly for facilitate the cutting step and for preventing the insulator layer and the conductor layer of the high frequency module 1 from being exposed. This point will be described later again. In addition, the first groove 33 and the second groove 34 are formed by performing a predetermined grooving process on the substrate member 30 without the grooves.

[Manufacturing Step Etc. of Module]

Next, a manufacturing process and the like of the high frequency module 1 will be described in more detail.

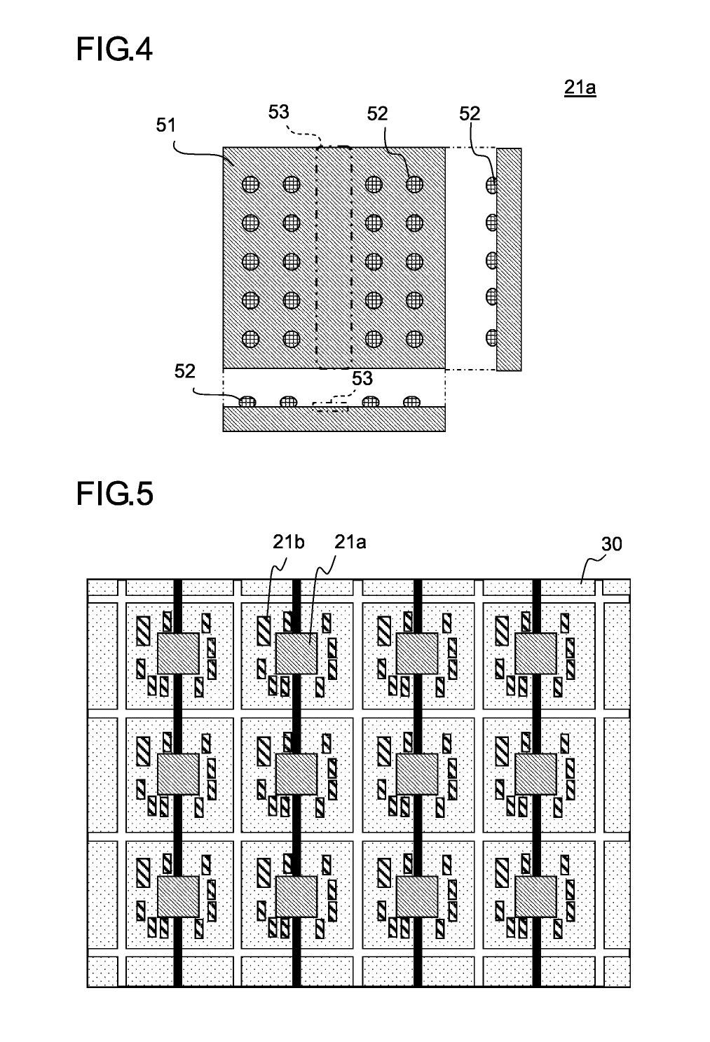

In the mounting step, each of the above-mentioned electronic components 21 is mounted on the component side of the substrate member 30. Further, as illustrated in FIG. 4, the IC chip 21a has a plurality of bumps 52 that are arranged on the flat mounting surface 51, but the bumps 52 are not arranged (are lacking) in a space 53 of a constant width from the center line of the mounting surface 51.

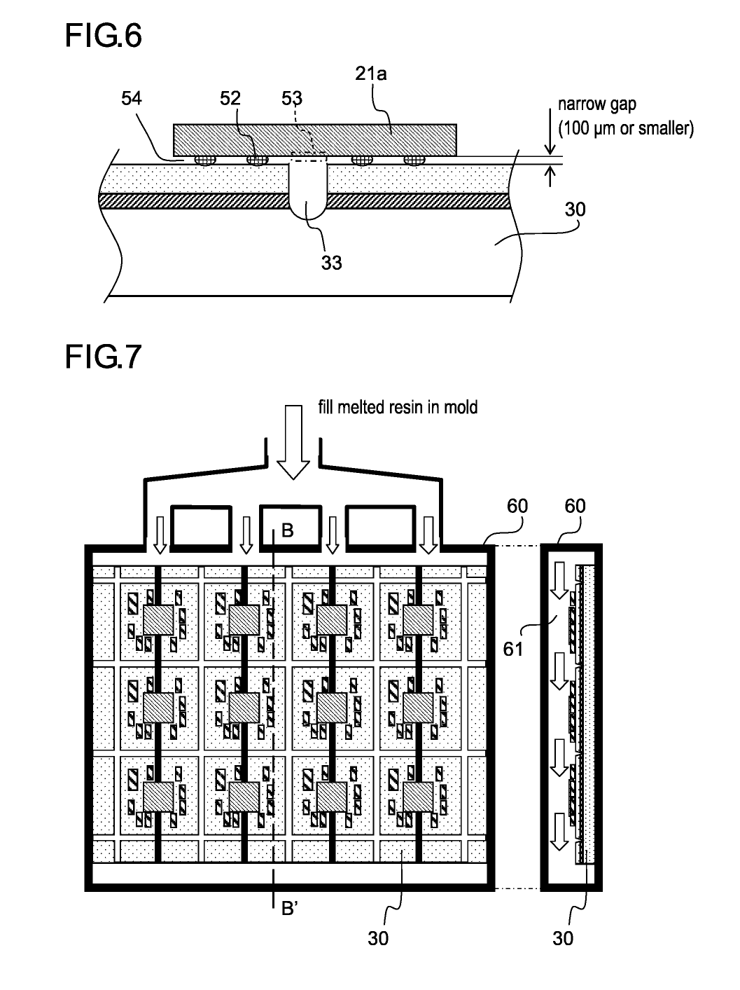

Then, the IC chip 21a is mounted on the component side of the substrate member 30 when the bumps 52 are glued to a predetermined positions of the first mounting region 32 as illustrated in FIG. 5. In this way, the IC chip 21a is mounted on the component side of the substrate member 30 by flip chip mounting (or face down mount). Note that the IC chip 21a is a narrow gap component. Therefore, in the state where the IC chip 21a is mounted on the substrate member 30, a gap (clearance) 54 between the mounting surface 51 of the IC chip 21a and the component side of the substrate member 30 is a narrow gap (100 μm or smaller, and usually 50 to 60 μm) as illustrated in FIG. 6. The gap 54 extends over the entire region of the first mounting region 32.

Further, being mounted in this way, as illustrated in FIG. 6, the space 53 in the mounting surface 51 is opposed to the first groove 33 of the substrate member 30. Therefore, the bump 52 is not disposed between the first groove 33 and the mounting surface 51. In other words, the first groove 33 is formed so as to avoid the portion where the bumps 52 are bonded. In addition, the first groove 33 and the gap 54 are communicated as a space between the substrate member 30 and the IC chip 21a.

In addition, each of the passive components 21b having substantially a rectangular parallelepiped shape is mounted at a predetermined position on the substrate member 30 as illustrated in FIG. 5 by soldering, for example. Note that each of the passive components 21b is mounted so that its longitudinal direction meets with the direction in which the resin flows in the sealing step. In addition, wiring between the electronic components 21 is basically realized in the conductor layer covered with the insulator layer and is not disposed on the component side.

In the sealing step, as illustrated in FIG. 7, the substrate member 30 after the mounting step is set inside a predetermined mold 60. Note that FIG. 7 illustrates the substrate member 30 set in the mold 60 viewed from top on the left side, and a cross sectional view taken along the line BB′ on the right side.

In the state set as described above, a space 61 (including the first groove 33 and the second groove 34) for the melted resin to flow is formed between the inner surface of the mold 60 and the component side of the substrate member 30. The resin is supplied to this space 61 from the outside of the mold 60. Thus, the resin flows as a whole in the direction of the arrows illustrated in FIG. 7 (i.e., substantially in a constant direction) and finally covers the entire of the component side of the substrate member 30. After that, the resin is set to be the resin layer sealing the electronic components 21 mounted on the substrate member 30.

This resin layer is cut together with the substrate member 30 in the cutting step later as described later, so as to be the sealing member 12. In other words, the resin layer is layers to be the sealing members 12 later, which are connected in the direction of the surface of the substrate member 30.

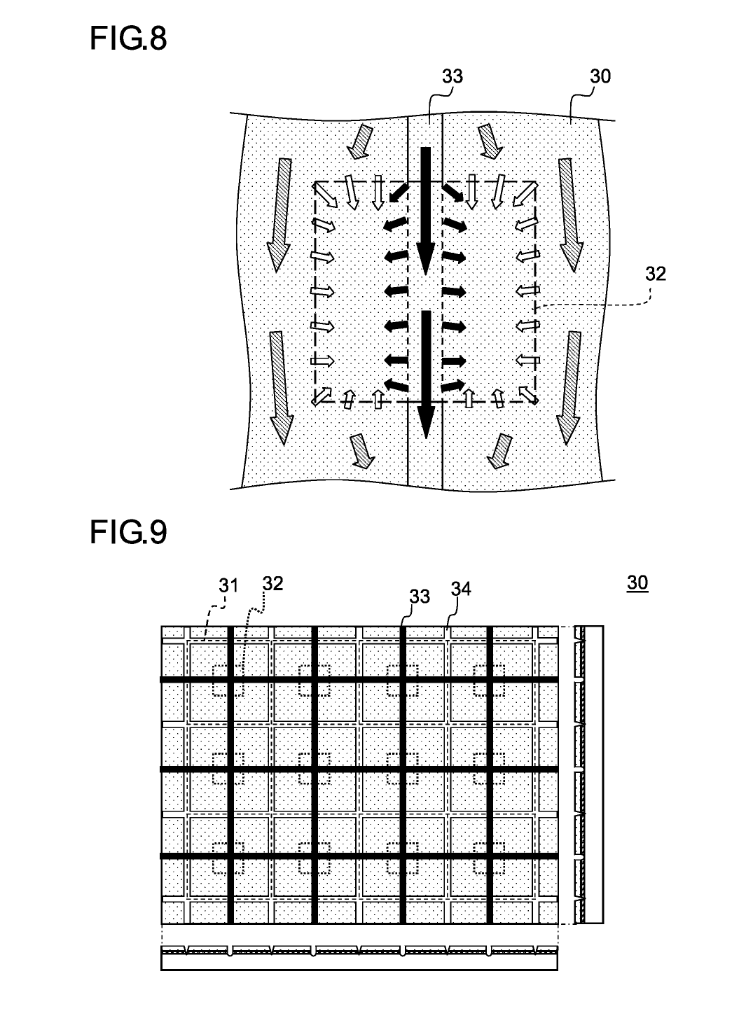

Here, filling of the resin in the gap 54 between the substrate member 30 and the IC chip 21a in the sealing step will be described with reference to FIG. 8. Note that FIG. 8 illustrates schematically the resin flow on the component side at the vicinity of the first mounting region 32.

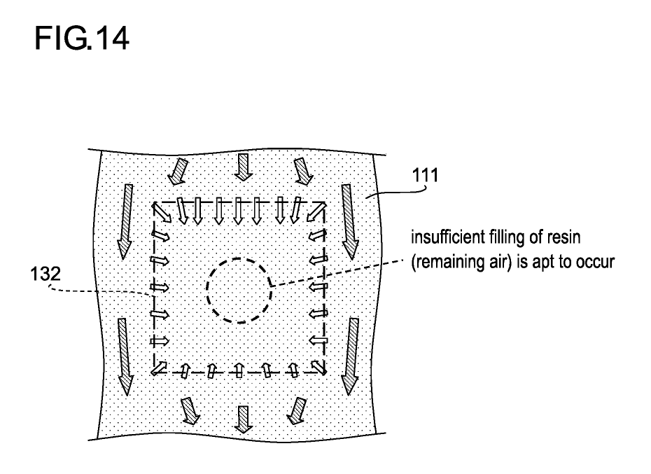

The gap 54 is opened to the outside of the gap 54 at the edge of the IC chip 21a. Therefore, the resin flows into the gap from the opening portion as illustrated by white arrows in FIG. 8. However, since the gap is very narrow, sufficient quantity (to fill up the gap 54 completely) of resin may not flow in from the opening portion. This is the same as the case of the conventional sealing step as described above (see FIG. 14).

However, since the first groove 33 is formed in the substrate member 30, the resin flowing in the space 61 can flow in the first groove 33. Thus, the resin flows through the first groove 33 and flows just below the IC chip 21a. Note that the direction in which the first groove 33 extends is set to be substantially the same as the direction in which the resin flows in the sealing step. Therefore, a power of this flow can be utilized for supplying the resin to the first groove 33 smoothly. In addition, since the bump 52 is not disposed in the space 53 (a portion of the IC chip 21a facing the first groove 33), the resin can flow in the first groove 33 more smoothly than the case where the bump 52 is disposed.

In addition, the gap 54 is communicated with the first groove 33 as a space at the first mounting region 32, and the resin can flow in through this communicated portion. Therefore, as illustrated by black arrows in FIG. 8, as part of the resin flowing in the first groove 33 flows into the gap 54.

In this way, according to this embodiment, resin flow channels from the outside of the gap 54 to the inside are secured more sufficiently, so that the resin can easily flow into the gap 54. As a result, the resin can flow evenly in the gap 54 and fill up the gap 54 completely more easily than the conventional method.

In addition, the passive components 21b are mounted so that the longitudinal direction thereof substantially meets the direction in which the resin flows in the sealing step. In other words, the mounting is performed so that an area of the passive components 21b disposed in the resin flow viewed from the direction of the resin flow becomes as small as possible. Therefore, in the sealing step, the resin flow is not disturbed by the passive components 21b as much as possible so that the resin can flow as much as possible.

When the sealing step is finished, a mounted substrate 30 with the resin layer formed on the component side is obtained. Further, in the cutting step, the substrate member 30 is cut together with the resin layer along the boundaries by using a blade or the like so as to be separated into pieces. The cutting direction is perpendicular to the surface of the substrate member 30. Note that the second grooves 34 are formed along the boundaries 31 of the substrate member 30, so that the parts with the second grooves 34 are thinner than other parts. Therefore, it is easier to cut by the blade along the boundaries 31 than the case without the second grooves.

A necessary process is performed on the separated pieces to be finally a module 1 as a finished product (as illustrated in the structural diagram of FIG. 1). In the module 1 manufactured in this way, insufficient filling of the resin in the gap 54 is suppressed as much as possible so that high quality thereof can be maintained easily.

[Others]

The groove portion 11a of the module 1 (see FIG. 1) is provided as a result of the first groove 33, and the slope portion 11b (see FIG. 1) is provided as a result of the second groove 34.

Here, the depth of the second groove 34 is set to be deeper than the insulator layer and the conductor layer of the substrate member 30 as described above. Therefore, the cut end portion in the cutting step is in the state where the insulator layer and the conductor layer are covered with the sealing member 12 (the state where the slope portion 11b is covered with the resin), so that the insulator layer and the conductor layer are not exposed to the outside. Note that the angle α of the V shape of the second groove 34 in the cross section is 90 degrees or smaller. Therefore, an angle of the slope at the slope portion 11b (an angle between the direction perpendicular to the component side and the slope surface is 45 degrees or lower (a half of the angle α).

In addition, the grooves like the first groove 33 for boosting the resin to fill the gap 54 is not limited to the above-mentioned form but can be various forms. For instance, as illustrated in FIG. 9, the grooves may be disposed so as to cross each other in the middle of the first mounting region 32 and to extend in both the vertical direction and the horizontal direction. If the grooves formed in the mounted substrate 30 extend inside and outside the first mounting region 32, the resin can flow from the outside of the first mounting region 32 to the inside (i.e., the gap 54) more easily than the case without the grooves, so that filling of the resin into the gap 54 can be boosted as the effect.

In addition, the depth of the first groove 33 can be set variously in accordance with the situation. For instance, the depth of the first groove 33 may be kept within the insulator layer 30c or may reach the conductor layer 30b. In addition, the depth of the first groove 33 may reach the base layer 30a.

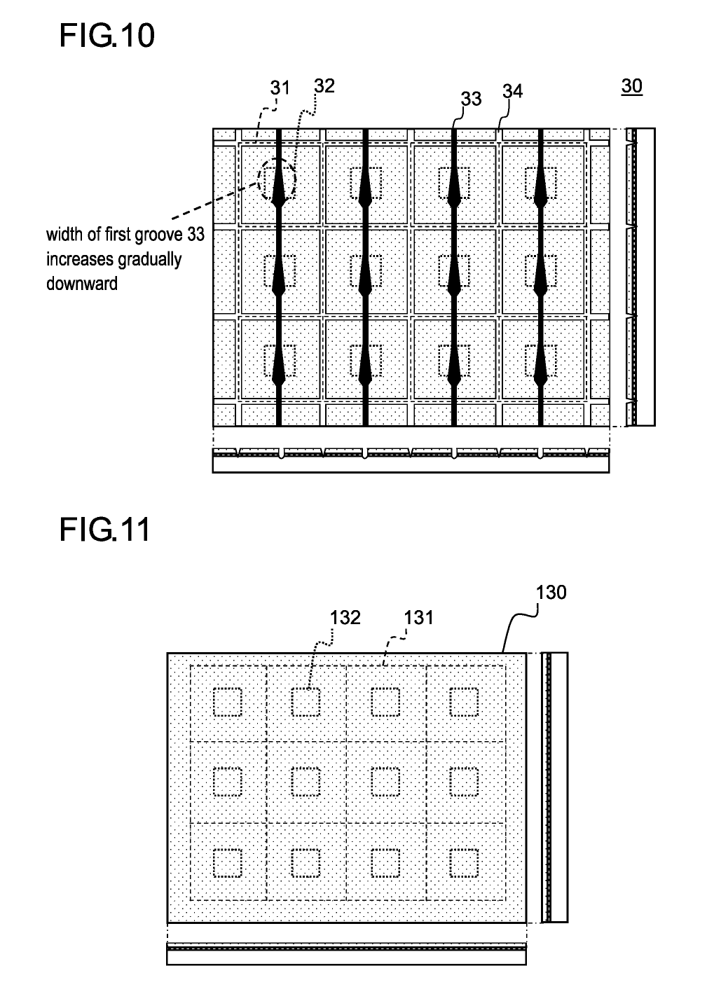

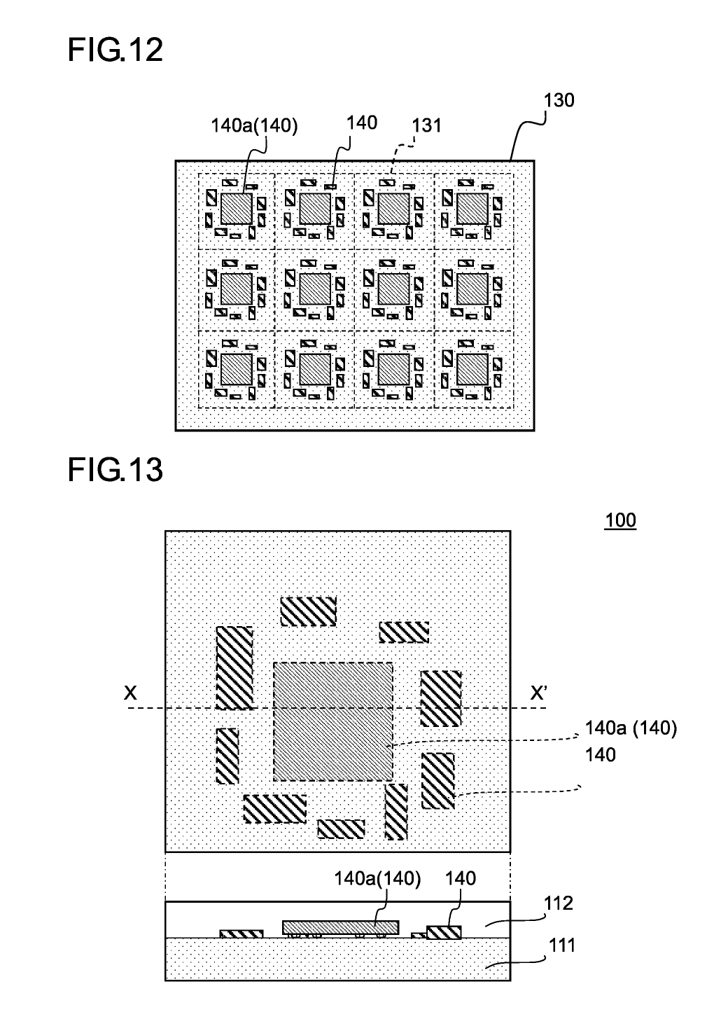

In addition, in each of the first mounting regions 32, the cross sectional area (width and depth) of the first groove 33 may be set so as to increase from the upstream to the downstream in the resin flow direction in the sealing step. For instance, as illustrated in FIG. 10, the width of the first groove 33 may be set so as to increase gradually. With this structure, it is expected that the resin can flow in the first groove 33 more easily in the first mounting region 32.

As described above, the substrate member 30 of this embodiment is a manufacturing component of a high frequency module 1 including a module substrate 11 on which electronic components 21 are mounted and are sealed with resin, and the substrate member 30 has substantially a plate-like shape and is to be the module substrate 11 later. In addition, the manufacturing process of the high frequency module 1 includes a mounting step of mounting the electronic components 21 on the component side of the substrate member 30, a sealing step of supplying resin to flow on the component side so as to seal the mounted electronic components 21 with the resin. In addition, this mounting step includes the step of mounting the IC chip 21a (first electronic component) having substantially a flat mounting surface 51 in the first mounting region 32 specified on the component side so that a gap 54 is provided between the mounting surface 51 and the component side. Further, the first grooves 33 for boosting the resin to fill the gap 54 in the sealing step are disposed on the component side of the substrate member 30.

In this way, since the first grooves 33 are disposed on the component side of the substrate member 30, filling of the resin into the gap 54 is boosted more than the case without the first grooves. Therefore, insufficient filling of the resin in the gap 54 can be suppressed as much as possible.

Although the embodiment of the present invention is described above, the present invention is not limited to the embodiment. In addition, the embodiment of the present invention can be modified variously as long as the spirit of the present invention is not deviated. In addition, although this embodiment exemplifies the high frequency module that is used as a component of communication equipment, this should not be interpreted as a limitation. The module may be one that is used for other type of electric equipment or may be a module having other functions.

Further, according to the substrate member of the present invention, since the first grooves are formed on the component side of the substrate member, filling of the resin into the gap between the substrate member and the electronic component can be boosted compared with the case where the first grooves are not formed. Therefore, insufficient filling of the resin in the gap can be suppressed as much as possible. In addition, according to the manufacturing method of the module according to the present invention, it is possible to utilize a merit of the first grooves in manufacturing the module.

What is claimed is:

1. A substrate member that is a manufacturing component of a module including electronic components mounted on a substrate and sealed with resin, wherein
the substrate member has substantially a plate-like shape and is to be the substrate later,
a manufacturing process of the modules includes a mounting step of mounting electronic components on a component side of the substrate member, and a sealing step of supplying resin to flow on the component side so that the mounted electronic components are sealed with the resin,
the mounting step includes mounting a first electronic component having substantially a flat mounting surface in a first mounting region specified on the component side so that a gap is formed between the mounting surface and the component side, and
the component side is provided with a first groove for boosting the resin to fill up the gap in the sealing step.

2. A substrate member according to claim 1, wherein the first groove is formed so as to pass through the first mounting region.

3. A substrate member according to claim 2, wherein
an outer edge of the substrate member has substantially a rectangular shape, and
the first groove is formed so as to extend from one side of the outer edge of the substrate member to the other side opposed to the one side.

4. A substrate member according to claim 3, wherein
the sealing step uses a transfer mold method in which the resin is supplied to flow in substantially the same direction along the component side of the substrate member, and
the first groove is formed so that the extending direction thereof is substantially the same as the direction of the resin flow.

5. A substrate member according to claim 4, wherein a width of the first groove in the first mounting region is adapted to increase along the direction of the resin flow.

6. A substrate member according to claim 4, wherein, in the mounting step, the first electronic component is mounted on the substrate member by gluing bumps of the mounting surface to predetermined positions in the first mounting region, and the first groove is formed so as to avoid the part where the bumps are glued.

7. A substrate member according to claim 4, wherein the first groove is formed so as to pass through substantially the middle of the first mounting region.

8. A substrate member according to claim 4, wherein
the substrate member includes individual parts that are to be substrates of different modules, and the parts are connected in the extending direction of the component side,
the manufacturing process of the modules includes cutting the substrate member together with the resin after the sealing step along the boundaries between the parts so as to separate the same into pieces, and
a second groove for the resin to flow in the sealing step is formed along the boundaries on the component side.

9. A substrate member according to claim 8, wherein the second groove is a V-shaped groove having an angle of substantially 90 degrees or smaller.

10. A substrate member according to claim 8, wherein
the substrate member includes an insulator layer to be an insulation coating of the modules and a conductor layer to be wiring patterns for the modules, and
a depth of the second groove is deeper than the insulator layer and the conductor layer.

11. A manufacturing method of modules, wherein the method uses the substrate member according to claim 4 as a manufacturing component.

12. A manufacturing method of modules, wherein the method uses the substrate member according to claim 8 as a manufacturing component.

13. A manufacturing method of a module including a substrate on which electronic components are mounted and sealed with resin, the method comprising:
a mounting step of mounting the electronic components on a component side of a substrate member that has substantially a plate-like shape and is to be the substrate later; and
a sealing step of supplying resin to flow on the component side so that the mounted electronic components are sealed with the resin, wherein
the mounting step includes mounting a first electronic component having substantially a flat mounting surface in a first mounting region specified on the component side so that a gap is formed between the mounting surface and the component side,
the component side is provided with a first groove that passes through the first mounting region, and
the sealing step includes supplying the resin to flow also in the first groove so that the resin flows from the first groove to the gap in the first mounting region for boosting the resin to fill up the gap.

14. A manufacturing method according to claim 13, wherein
the mounting step includes mounting passive components having substantially a rectangular parallelepiped shape on the component side of the substrate member,
the sealing step uses a transfer mold method in which the resin is supplied to flow in substantially the same direction along the component side of the substrate member, and
all the passive components mounted on the component side in the mounting step are mounted so that the longitudinal directions of the passive components are substantially the same as the direction of the resin flow.

15. A manufacturing method according to claim 13, wherein in the mounting step, the first electronic component is mounted on the component side of the substrate member so that the gap is 100 μm or smaller.

16. A module manufactured by the manufacturing method according to claim 11.

17. A module manufactured by the manufacturing method according to claim 13.

18. An electric equipment comprising the module according to claim 16 as one of components.

19. An electric equipment comprising the module according to claim 17 as one of components.
